(19) United States
(12) Patent Application Publication
(10) Pub. No.: US 2025/0270089 A1
(43) Pub. Date: Aug. 28, 2025

(54) SYSTEM AND METHOD FOR PRODUCING HYDROGEN GAS FROM DIESEL FUEL USING A REFORMER OR OTHER HYDROGEN GAS PRODUCTION SYSTEM AND FOR MIXING THE HYDROGEN GAS BACK INTO THE LIQUID DIESEL FUEL PRIOR TO SENDING THE LIQUID DIESEL FUEL INTO A HYDRO-DIESEL ENGINE

(71) Applicant: H2DIESEL, INC., Lewes, DE (US)

(72) Inventor: John S. PETTERSON, La Jolla, CA (US)

(73) Assignee: H2DIESEL, INC., Lewes, DE (US)

(21) Appl. No.: 18/695,682

(22) PCT Filed: Nov. 13, 2023
(86) PCT No.: PCT/US2023/037208

§ 371 Date: Mar. 26, 2024

Related U.S. Application Data
(60) Provisional application No. 63/425,906, filed on Nov. 16, 2022.
(60) Provisional application No. 63/539,239, filed on Sep. 19, 2023.

(51) Int. Cl. C01B 3/34; C01B 3/24; C01B 3/36

(52) U.S. Cl. CPC C01B 3/342; C01B 3/24; C01B 3/36; C01B 2203/0233; C01B 2203/0244; C01B 2203/025; C01B 2203/085; C01B 2203/0855; C01B 2203/0861; C01B 2203/1247

(57) ABSTRACT

A method of enhancing diesel fuel combustion by adding reformed hydrogen to the diesel fuel, by: (a) extracting hydrogen gas from liquid diesel fuel with a reformer/hydrogen generation system; (b) bubbling and agitating the extracted hydrogen gas into the liquid diesel fuel to form a homogenous mixture of hydrogen gas in liquid diesel fuel; (c) compressing the homogenous mixture of hydrogen gas in liquid diesel fuel at high pressures; and then (d) receiving both air and the compressed homogenous mixture of hydrogen gas in liquid diesel fuel into a combustion chamber.

### RELATED APPLICATIONS

The present application claims priority to U.S. Provisional Patent Applications Ser. No. 63/425,906, entitled System and Method for Making Hydrogen from Diesel Fuel Using a Reformer for a Hydro-Diesel Engine, filed Nov. 16, 2022; and Ser. No. 63/539,239, entitled System and Method for Making Hydrogen from Diesel Fuel Using a Reformer or Other Hydrogen Gas Production System for a Hydro-Diesel Engine, filed Sep. 19, 2023, the entire disclosures of which are incorporated herein by reference in their entireties for all purposes.

### TECHNICAL FIELD

The present system relates to diesel fuel engines and more particularly a Diesel Engine that uses a combination of liquid diesel fuel and hydrogen gas in a hydro-diesel engine where the hydrogen gas is produced using on board diesel fuel reformer technology, or other onboard hydrogen gas production from diesel fuel systems and then is mixed back into the diesel fuel prior to the diesel fuel entering the engine.

### BACKGROUND OF THE INVENTION

A conventional diesel engine passes diesel fuel at a nominal pressure from the fuel tank to the lift pump. The lift pump pressurizes the fuel (150 to 200 psi) and passes the fuel on to an injector pump. The injector pump then pressurizes the fuel to injector pressures (2,000 to 40,000 psi) and then passes the fuel onto a common rail for subsequent injection into the combustion chamber. Air is passed into the combustion chamber through the air intake as the piston in the chamber recedes. As the piston rises it squeezes the air volume heating up air raising the air to a temperature that causes the diesel fuel that is injected into the chamber as the piston moves to Top Dead Center (TDC) to spontaneously combust (explode) increasing the pressure in the chamber and forcing the piston down.

The conventional source of the hydrogen gas in a standard hydro-diesel engine is from a pressurized hydrogen tank or from a water hydrolysis device. Unfortunately, a disadvantage of using bottled hydrogen gas is that it is heavy, difficult to maneuver, and limited in capacity. On board electrolysis systems exist to generate hydrogen gas but the electrolysis is also cumbersome, requires constant attention, and is susceptible to accidental combustion. The proximity of H2 and O2 causes explosive risks.

### SUMMARY OF THE INVENTION

The present application is directed to a hydro-diesel engine that provides a substantial improvement in efficiency and reduction of noxious greenhouse gases over that generated by a conventional diesel engine using conventional diesel fuel. Except for the infuser and the hydro-diesel fuel mixture, the operation of the present hydro-diesel engine is similar to that of a conventional diesel engine. The conventional source of the hydrogen gas in a standard hydro-diesel engine is from a pressurized hydrogen tank or from a water hydrolysis device. In contrast, the present system produces hydrogen gas onboard using a reformer or other diesel fuel to hydrogen techniques which is then mixed back into the diesel fuel prior to it entering the engine. Alternative embodiments of the present system also include mixing hydrogen gas with other gaseous fuels and/or oxidizer to the diesel fuel. In an alternative embodiment of the present hydro-diesel engine, oxygen is added to further augment the diesel fuel-hydrogen mixture. Air is passed into the combustion chamber through the air intake. The present hydro-diesel fuel mixture is injected into the chamber as the piston raises to TDC. The hydro-diesel engine provides a more complete combustion of the fuel by using and injecting the hydro-diesel fuel to provide a more efficiency combustion of upwards of 30%.

As will be described herein, the present system preferably uses a reformer to generate the hydrogen. Reformer generated hydrogen avoids the above mentioned complications. In other preferred embodiments, hydrogen gas is instead generated through plasma systems, including, but not limited to, plasma reformers and plasma electrolysis systems. Such plasma systems may optionally include pre-heating of the plasma system with heated exhaust gasses. Plasma torches and plasma microwave system may be used to generate the hydrogen gas. Catalytic systems can also be used for hydrogen generation with a plasma providing the necessary high temperatures to facilitate this reaction. Plasma pyrolysis systems may be used to instead produce the hydrogen from methane, or plasma decomposition of ammonia is also contemplated as a hydrogen gas production source. Plasma reforming processes may include: dielectric barrier discharge (DBD) reactors, pulsed plasma reactors, gliding arc plasma reactors, and microwave (MW) plasma reactors.

The present invention is directed to a method and device for the real time refinement of hydrogen from liquid diesel fuel using hydrogen reformer technology or other systems of onboard hydrogen gas generation from diesel fuel. The reformer (or otherwise produced) hydrogen gas is the source hydrogen used in the present hydro-diesel engine process which combines liquid diesel fuel with hydrogen gas. Alternative protocols are also encompassed herein for operation of the hydro-diesel engine such as additional and alternative gaseous additives and alternatives structures for combining gas additives back into liquid diesel fuel, again preferably using reformer hydrogen.

Importantly, with reference to the present invention, the structure and operation of a hydro-diesel engine is new and provides a significant increase in fuel efficiency and reduction of noxious exhaust gasses. In contrast to existing systems, the present system need not rely on bottled high pressure hydrogen gas and/or hydrogen gas generated from an electrolysis device.

The present invention optionally uses diesel reformer technology as an enhanced alternative supply of hydrogen gas. Specifically, the present system uses the on board source diesel fuel, (which is nominally and abundantly available within the vehicle or power generator) as the source of the hydrogen gas. Many variations of diesel fuel reformer technology are known for adaption and use, alone or in combination, and are encompassed herein as alternative systems for generating the needed hydrogen gas. Other hydrogen generation systems, including, but not limited to, plasma reformers may also be used in accordance with the present invention. Included plasma reforming processes may include: dielectric barrier discharge (DBD) reactors, pulsed plasma reactors, gliding arc plasma reactors, and microwave (MW) plasma reactors. Such plasma systems may optionally include pre-heating of the plasma system with heated exhaust gasses. Moreover, plasma torches and plasma microwave system may also be used to generate the hydrogen gas. In addition, catalytic systems may also be used for hydrogen generation with a plasma providing the necessary high temperatures to facilitate this reaction. Plasma pyrolysis systems may also optionally be used to instead produce the hydrogen from methane, and plasma decomposition of ammonia is also contemplated as a hydrogen gas production source, all keeping within the scope of the present system.

One advantage of the present system of using diesel fuel for generating reformed hydrogen gas is that it reduces the infrastructure required (as compared to other hydrogen source generators). Those skilled in the art are capable of adapting the present equipment and techniques of generating hydrogen gas from one or more reformer or other technologies. In short, the present invention is thus directed in one embodiment to the new and novel structure of using a diesel reformer as the hydrogen source for a hydro-diesel engine. Advantageously, the present system thus provides a substantial reduction in the complications of securing hydrogen gas to mix into the liquid diesel fuel passing into the hydro-diesel engine.

In preferred aspects, the present system increases the efficiency of diesel fuel combustion by extracting hydrogen gas from a liquid diesel fuel source and then mixing the extracted hydrogen gas back into the liquid diesel fuel before sending the resulting mixture into the combustion chamber. This process is completely new and has never been considered prior to the present system. In preferred aspects, the hydrogen gas is extracted from the liquid diesel fuel by passing a portion of the liquid diesel fuel through a reformer.

In a preferred aspects, the reformer technology used herein may include any one of:
(i) a steam reforming system (in which hydrocarbons are reacted with water such that produced hydrogen can be stored and waste carbon dioxide released to the atmosphere), or
(ii) a partial oxidation reforming system (in which an air-fuel mixture is only partially combusted in a reformer), or
(iii) plasma reforming technologies, for example, dielectric barrier discharge (DBD) reactors, pulsed plasma reactors, gliding arc plasma reactors, and microwave (MW) plasma reactors.

These technologies are known and those skilled in the art are capable of optimizing which technique of combinations of techniques is best suited for particular applications. The present system is therefore directed to combining these technologies with the hydro-diesel engine for improved, simplified and cost effective operation of the engine.

One advantage of the present reformer system is that it reduces greenhouse and noxious gas emissions (due to the burn being more efficient). Another advantage of using a reformer is that it is energy efficient. Yet another advantage of using a reformer is that it is relatively inexpensive.

In preferred aspects, the present system provides a method of enhancing diesel fuel combustion by adding reformed hydrogen (or hydrogen generated with other systems described herein) to a diesel fuel, comprising:
(a) providing a supply of liquid diesel fuel;
(b) extracting hydrogen gas from the liquid diesel fuel, wherein the hydrogen gas is extracted from the liquid diesel fuel by a reformer;
(c) bubbling and agitating the extracted hydrogen gas into the liquid diesel fuel to form a homogenous mixture of hydrogen gas in liquid diesel fuel;
(d) compressing the homogenous mixture of hydrogen gas in liquid diesel fuel thereby reducing the size of hydrogen bubbles in the homogenous mixture of hydrogen gas in liquid diesel fuel;
(e) receiving air into a combustion chamber through an air intake;
(f) injecting the compressed homogenous mixture of hydrogen gas in liquid diesel fuel into the combustion chamber;
(g) decreasing the pressure on the hydrogen gas in the mixture of hydrogen gas in liquid diesel fuel in the combustion chamber thereby permitting the size of hydrogen bubbles to expand in the homogenous mixture of hydrogen gas in liquid diesel fuel in the combustion chamber; and then
(h) subjecting the air and diesel and gas mixture to compression thereby causing the air to heat and ultimately combusting the air with the hydrogen gas and liquid diesel fuel mixture in the combustion chamber in a more complete and efficient burn which generates an efficient engine mileage/burn rate.

### BRIEF DESCRIPTION OF THE DRAWINGS

FIG. 1 shows a conventional diesel engine.

FIG. 2 shows a schematic of the present system for passing a portion of liquid diesel fuel into a reformer (or other hydrogen generation system as described herein) to extract hydrogen gas before mixing the extracted hydrogen gas back into the liquid diesel fuel and injecting the resulting mixture into the combustion chamber.

FIG. 3 shows a close-up view of the preferred reformer and a hydrogen buffer tank.

### DETAILED DESCRIPTION OF THE DRAWINGS

s(a) System Overview:

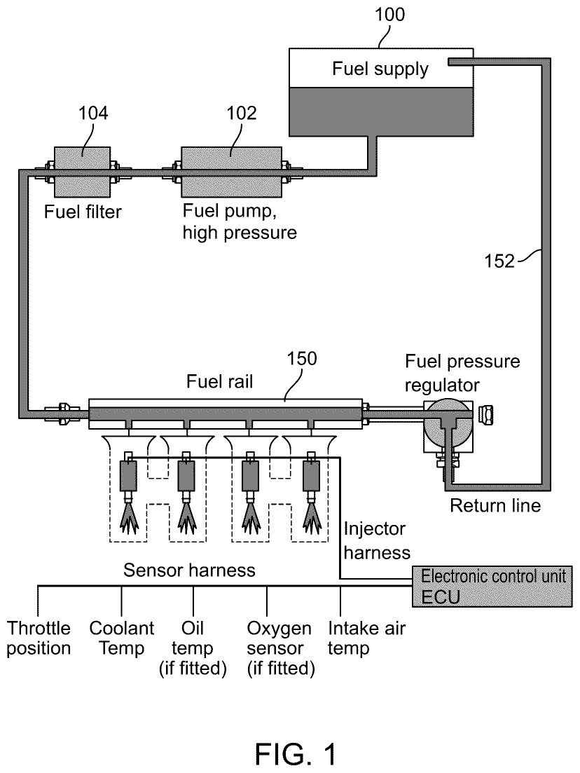

FIG. 1 shows a conventional diesel engine having a fuel supply 100, fuel pump 102 and filter 104. The fuel is combusted in the fuel rail 150. Unused fuel is returned to the fuel source through return line 152.

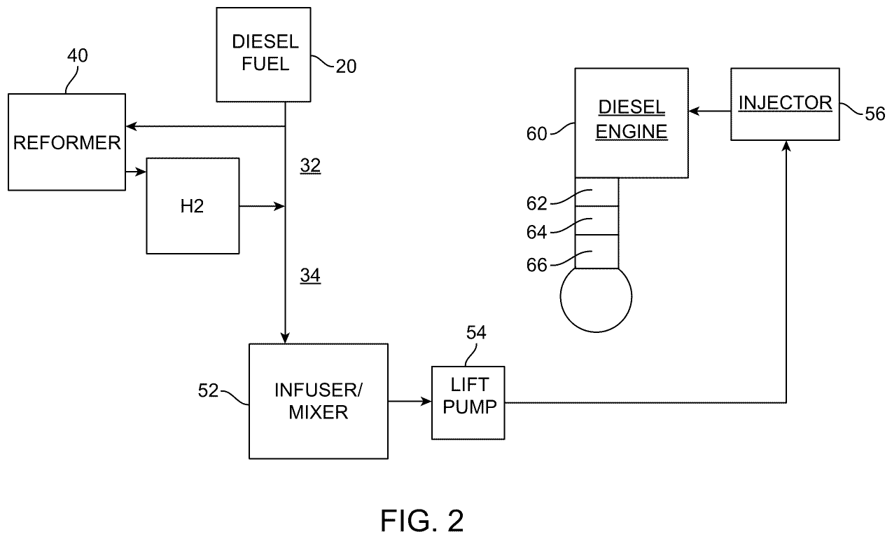

FIG. 2 shows a system 10 for enhancing the efficiency of diesel combustion, as follows.

A source or tank 20 of diesel fuel is provided. As diesel fuel leaves tank 20, a first portion 30 will be directed into reformer 40 which will extract hydrogen therefrom. The hydrogen H2 will then be mixed into the second portion 32. This process will result in a gas/fuel mixture 34. The diesel fuel that enters reformer 40 may then optionally be discarded as waste, or put back into the system.

Preferably, in accordance with the present system, the mixing of reformed hydrogen back into the diesel fuel to form a gas/fuel mixture 34 is carried out by adding the reformed hydrogen to a diesel fuel, by: bubble injecting hydrogen gas into the liquid diesel fuel then infusing (mixing) the combination to form a homogenous mixture of hydrogen in liquid diesel fuel; and then pressuring the mixture to compress the hydrogen gas bubbles distributed throughout the diesel fuel by, for example, a lift pump, to reduce the size of the hydrogen bubbles in a the homogenous mixture of hydrogen gas in diesel fuel.

In other optional embodiments, element 40 represents another system for hydrogen gas generation, including, but not limited to, plasma reformers such as dielectric barrier discharge (DBD) reactors, pulsed plasma reactors, gliding arc plasma reactors, and microwave (MW) plasma reactors. Such plasma systems may optionally include pre-heating of the plasma system with heated exhaust gasses.

In other optional embodiments, element 40 may optionally include plasma torches and plasma microwave system may be used to generate the hydrogen gas. Alternatively, element 40 may include catalytic systems for hydrogen generation with a plasma providing the necessary high temperatures to facilitate this reaction. In further optional embodiments, plasma pyrolysis systems may also optionally be used to instead produce the hydrogen from methane, or plasma decomposition of ammonia is also contemplated as a hydrogen gas production source.

The mixture of hydrogen gas in liquid diesel fuel is injected into the combustion chamber 62 via the injector pump 56 at 2,000 to 40,000 psi passing the fuel mixture into the common rail 60. Air is drawn into the combustion chamber 62 on the piston's 66 inwardly movement. The piston 66 then starts it outward movement compressing the air within the chamber 62. The homogenized mixture of hydrogen gas and diesel fuel is atomizedly injected into the combustion chamber 62, when the piston 66 position is at or about top dead center, via injector 64. The chamber 62 at this point is at a much reduced pressure 500 to 800 psi, permitting the minute hydrogen bubbles in the homogenized mixture of hydrogen and diesel fuel to immediately and violently expand and increase in size causing great agitation and distribution of the diesel fuel disrupted into minute droplets throughout the chamber. The piston 66, on its outward movement, compresses the air within the chamber resulting in heated air sufficient to spontaneously combust the particulate diesel fuel and hydrogen gas.

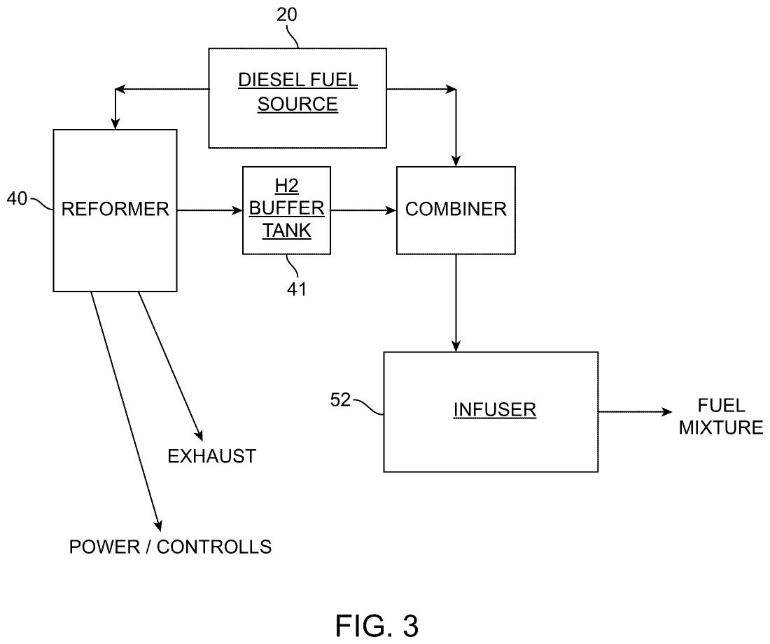

FIG. 3 shows a close up of reformer/hydrogen generation system 40 connected to a hydrogen buffer tank 41. Buffer tank 41 allows the present system to maintain a continuous hydrogen supply should there be an immediate increase or slowdown in the hydrogen required by the infuser. As illustrated, reformer 40 may be positioned to be heated by the exhaust of the engine. Such heating facilitates the reforming reaction. In one preferred aspect, the chemical reaction in the reformer is:

CH4+½O2→CO+2H2

In preferred aspects, reformer/hydrogen generation system 40 may be any one of: (a) a steam reforming system, (b) a partial oxidation reforming system, or (c) an autothermal reforming system. It is to be understood, however, that reformer 40 may be any other form of reformer or reforming technology that functions to remove or extract hydrogen gas from the diesel fuel (coming from tank 20). For example, various reforming technologies can include an endothermic reformer such as a steam reformer.

Various reformers 40 and reforming technologies are discussed below and may be suitable for inclusion into the present system, as follows:

### (b) Suitable Reformers for Use as Reformer 40 Illustrated in the Present System:

There are several different approaches and technologies for reforming hydrogen gas from diesel fuels. For example, these include steam reforming and partial oxidation reforming, and autothermal reforming (which combines features of both steam reforming and partial oxidation systems). In autothermal reforming, a hydrocarbon feed is reacted with both steam and air to produce a hydrogen-rich gas. Both the steam reforming and partial oxidation reactions take place. With the right mixture of input fuel, air and steam, the partial oxidation reaction supplies all the heat needed to drive the catalytic steam reforming reaction. This makes autothermal reformers simpler and more compact than steam reformers. Autothermal reformers typically offer higher system efficiency than partial oxidation systems, where excess heat is not easily recovered.

In one exemplary system illustrated in US Patent Publication 2015/0136047 entitled “Mixed-Mode Combustion Methods Enabled by Fuel Reformers and Engines Using the Same”, incorporated herein by reference in its entirety, a suitable autothermal reformer for use in accordance with the present system is shown. This system uses an atomizer with a rotating arm, to produce ultrafine atomization of diesel fuel through leveraging the high pressure produced by the centrifugal forces of the rotating arm. This system addressed the problem of diesel fuel being generally difficult to vaporize, therefore requiring high temperatures which can lead to pyrolysis and coking (carbonaceous deposits).

In another exemplary system illustrated in U.S. Pat. No. 10,815,123 entitled “Engine fuel-reforming reactors, systems, and methods” a reforming reactor within the exhaust gas manifold operates as a heat exchanger to promote the reforming process.

In another exemplary reformer system, illustrated in U.S. Pat. No. 6,641,625, entitled “Integrated hydrocarbon reforming system and controls” an autothermal reformer having distinct Zones for partial oxidation reforming and for steam reforming is provided.

In another exemplary reformer system, illustrated in U.S. Pat. No. 6,804,950, entitled “Plasma reforming and partial oxidation of hydrocarbon fuel vapor to produce synthesis gas and/or hydrogen gas”, a reformer is used to generate hydrogen gas that is sent straight into the combustion chamber.

In another exemplary reformer system, illustrated in U.S. Pat. No. 7,946,258, entitled “Method and apparatus to produce enriched hydrogen with a plasma system for an internal combustion engine”, a reformer is also used to generate hydrogen gas that is sent straight into the combustion chamber.

In another exemplary reformer system, illustrated in U.S. Pat. No. 9,388,749, entitled “System and method for improving performance of combustion engines employing primary and secondary fuels”, a reformer is also used to generate hydrogen gas that is sent straight into the combustion chamber.

Yet another suitable example of reformer technology is found in U.S. Pat. No. 10,920,717, entitled “Hydrogen producing system and device for improving fuel efficiency and reducing emissions of internal combustion and/or diesel engines”. This system, however, simply injects the reformed hydrogen into the combustion chamber through the air intake.

Yet another suitable example of reformer technology is found in U.S. Pat. No. 11,239,479 entitled “Ignition method of fuel reformer using partial oxidation reaction of the fuel for SOFC fuel cell start-up” which reforms hydrogen for use in a fuel cell.

Although the above discussed reformers do produce hydrogen gas, the hydrogen gas is simply sent directly into the combustion chamber of the engine. In contrast, the present reformer system produces hydrogen gas which is instead mixed back into the diesel fuel prior to the diesel fuel being sent into the combustion chamber of the engine (where it is then combusted together with oxygen (e.g.: air) entering the combustion chamber). As such, the present reformer-generated hydrogen forms part of the liquid fuel that is combusted together with air or other gases in the combustion chamber.

It is to be understood, however, that any of the reformer technologies discussed in any of the above mentioned patents could instead be used for producing hydrogen gas in accordance with the present system (i.e.: producing hydrogen gas which is then mixed back into the liquid diesel fuel prior to the liquid diesel fuel reaching the engine). As such, all of the patents referred to herein are incorporated by reference in their entireties into the present application.

Steam reforming involves exposing a mixture of steam and hydrocarbon fuel to a suitable catalyst at a high temperature. The catalyst used is typically nickel and the temperature is usually between about 700° C. and about 1000 C.

Another conventional method of reforming a gaseous or liquid hydrocarbon fuel is partial oxidation (POX) reforming. In these processes, a mixture of the hydrocarbon fuel and an oxygen containing gas are brought together within a POX chamber and subjected to an elevated temperature, preferably in the presence of a catalyst. The catalyst used is normally a noble metal or nickel and the high temperature is normally between about 700° C. and about 1200° C. for catalyzed reactions, and about 1200° C. to about 1700 C. for non-catalyzed reactions.

The catalytic partial oxidation reforming technique is simpler than the catalytic Steam reforming technique, but is not as thermally efficient as catalytic Steam reforming. An additional known method of reforming a hydrocarbon fuel is by autothermal reforming, or “ATR’. An autothermal reformer uses a combination of Steam reforming and partial oxidation reforming. Waste heat from the partial oxidation reforming reaction is used to heat the thermally Steam reforming reaction. An autothermal reformer may in many cases be more efficient than either a catalytic Steam reformer or a catalytic partial oxidation reformer.

### (c) Additional Aspects of the Present System:

Additional aspects of the present system, as built and tested by the Applicant operated as follows.

Hydrogen, under low pressure (3 to 5 psi), was injected into the low pressure (3 to 5 psi) liquid diesel fuel line from the fuel tank. This hydrogen is preferably injected in small bubbles (atomized). The hydrogen is infused into the diesel fuel by passing the combination of hydrogen and diesel fuel through infuser 52 having a defined length of a defined diameter tubing where the hydrogen is thoroughly mixed and distributed, homogenized, throughout the diesel fuel. In addition the fuel gas mixture is pressurized (40 to 100 psi) compressing the hydrogen bubbles into smaller volumes.

The fuel gas mixture was then passed to the lift pump 54 of the conventional diesel engine where the pressure of the fuel gas mixture is increased (100 to 200 psi) thereby compressing the volume of the hydrogen gas bubbles. The fuel gas mixture is then passed to the injector pump 56 of the conventional diesel engine substantially increasing the fuel gas mixture pressure (2,000 to 40,000 psi) and substantially decreasing the size of the hydrogen bubble. The fuel gas mixture was then passed to the diesel engine common rail 60 where it is controllably injected into the separate combustion chambers.

The fuel gas mixture was atomized into small droplets as it was injected. Each droplet was imbedded with tiny compressed bubbles of hydrogen. As these fuel gas mixture droplets experience the decreased pressure of the inside of the combustion chamber the hydrogen bubbles immediately experience a rapid volumetric expansion further particulating the fuel, increasing the diesel fuel surface area and thereby permitting the more complete combustion of the fuel. In addition, the hydrogen that is injected into the combustion chamber 62 is released from the fuel gas mixture, expands throughout the combustion chamber and reacts with the 02 from the air via the air intake further contributing to the combustion.

A further consequence of injecting the hydrogen into the combustion chamber 62 as part of the fuel gas mixture results from the lower combustion flash point of hydrogen relative to diesel fuel. The lower hydrogen flash point causes the hydrogen to combust earlier which contributes to an earlier increase in heat causing he diesel fuel to ignite earlier and more completely. In addition and because the diesel fuel has experience additional particulation with greater surface area, the diesel fuel experiences a more complete combustion and increase in energy release, thereby increasing the combustion efficiency.

The hydrogen is being infused and adsorbed into the structure of the hydrocarbons or carried directly into the combustion chamber as compressed gaseous molecules or ionic hydrogen atoms with the injected fuel. It therefore does not carry the major shortcoming of air-intake induction of hydrogen into the combustion chamber, which effectively displaces (at stoichiometric conditions) combustion chamber air content (and the benefits of the oxygen).

As such, the hydrogen added during the infusion process is not merely mixed or blended. Through a sequence of chemical processes, the H ions are literally infused and adsorbed into the molecular structure of the hydrocarbons. At the heart of the hydro-diesel infusion system is the differential chemical reaction between the injected molecular hydrogen and the bonded hydrogen atoms of the various fractions of diesel fuel. The reaction appears to consist of several components: (a) the selective hydrogenolysis, or bond dissociation, of unsaturated double-bond aromatics, liberating an additional volume (approximately 2×) of hydrogen [fractional changes]: (b) the selective hydrogenation, or adsorption, of injected and liberated hydrogen atoms onto accessible carbon atoms in the single-bond long chain saturated isoparaffinics [molar changes]; and (c) the retention of a volume of liberated ionic hydrogen and injected hydrogen molecules in highly pressurized gaseous form, and thus immediately available in that form at the moment of flame propagation [combustion changes]. The largest, perhaps dominant, source of the observed fuel efficiency was a product of a significantly enhanced fuel combustion sequence.

Three principal sources of improved combustion efficiency can include: (a) the expansion physics of the infused hydrogen gas; (b) the induced turbulence, spray, and distributional effects, and (c) the enhanced combustion physics, as follows.

(a) Sudden Hydrogen Decompression Physics. The single largest change in the hydro-diesel combustion event is the presence of hydrogen at the instant of injection. At that instant, the injected diesel differs from virgin diesel in two fundamental way—first, the fractions of the fuel have been altered by the hydrogenation process (i.e., the selective addition and subtraction of hydrogen atoms by fuel fraction, and across molar distributions), and second, the fuel contains a small volume of extremely compressed hydrogen molecules (and ionic hydrogen atoms). These two changes can affect the combustion event in very different ways—one chemical, the other physical. Breaking the 3-millisecond injection event into a chronological sequence, the physics or kinetics of hydrogen expansion can predominate in the first millisecond.

(b) Enhanced Turbulence: The physics of sudden molecular expansion of hydrogen molecules is a novel variable in the combustion equation, directly affecting the event in several ways. First, the kinetic hydrogen expansion physically propels molecules independently, thereby altering the spray configuration and, just prior to ignition, magnifying and compounding the normal, and desirable, boundary turbulence and distribution critical to complete fuel consumption, fuel efficiency, and minimization of unburnt exhaust emissions. At a minimum, the hydrogen kinetics function to induce added expansive precombustion turbulence, ensuring a significant increase in surface area and, hence, high propagation speed and a sharp increase in cylinder pressure. The hydrogen gas molecules are also not burning in the same manner, or at the same time, or at the same place as the bonded hydrocarbon molecules. Their action, however, is directly affecting the expansion and stratification characteristics of flame propagation, increasing the surface area of the flame, the burn velocity, and the penetration of the burn throughout the chamber. The burn efficiency of the combustion event improves at each phase, from ignition initiation through bloom and decay. In sum, we believe the hydrogen molecules, undergoing explosive expansion at a microscopic scale, combined with liberated ionic H atoms, are effecting a far more powerful, distributed, uniform, and enduring combustion event.

(c) Combustion Effects: The high inertial, heavy mass, diesel hydrocarbon molecule will naturally concentrate near the center of the injection spray, while the large, light weight, rapidly expanding, and suddenly slowing and mixing hydrogen gas molecule (and ionic H atoms) will migrate to the periphery of the spray. Given that the principal chemical transformation of combustion takes place along the thin jet interfacial (boundary) region separating the unburned and the burned gases, this sequence, in theory, places the hydrogen gas at the ideal place at the ideal moment of combustion. It is important to note that the free (not adsorbed) ionic hydrogen produced during the infusion process is more reactive than molecular hydrogen, further accelerating the combustion physics.

It is to be understood that the presently disclosed systems are exemplary and that other suitable components and methods may also be used, as known to one skilled in the art, and that such components and methods are also understood to be encompassed within the scope of the present invention.

What is claimed is:

1. A method of enhancing diesel fuel combustion by adding reformed hydrogen to a diesel fuel, comprising:
(a) providing a supply of liquid diesel fuel;
(b) extracting hydrogen gas from the liquid diesel fuel, wherein the hydrogen gas is extracted from the liquid diesel fuel by a reformer/hydrogen generation system;
(c) bubbling and agitating the extracted hydrogen gas into the liquid diesel fuel to form a homogenous mixture of hydrogen gas in liquid diesel fuel;
(d) compressing the homogenous mixture of hydrogen gas in liquid diesel fuel at high pressures thereby reducing the size of hydrogen bubbles in the homogenous mixture of hydrogen gas in liquid diesel fuel;
(e) receiving air into the combustion chamber through an air intake;
(f) injecting the compressed homogenous mixture of hydrogen gas in liquid diesel fuel into a combustion chamber at a reduced pressure;
(g) decreasing the pressure on the hydrogen gas in the mixture of hydrogen gas in liquid diesel fuel at reduced pressures in the combustion chamber permitting the size of hydrogen bubbles to expand in the homogenous mixture of hydrogen gas in liquid diesel fuel in the combustion chamber; and then
(h) subjecting the air and diesel and gas mixture to compression thereby causing the air to heat and ultimately combusting the air with the hydrogen gas and liquid diesel fuel mixture in the combustion chamber in a more complete and efficient burn which generates an efficient engine mileage/burn rate.

2. The method of claim 1, wherein extracting the hydrogen gas by a reformer/hydrogen generation system comprises:
providing a supply of liquid diesel fuel,
splitting the supply of liquid diesel gas into a first stream and a second stream,
sending the first stream into the reformer/hydrogen generation system,
extracting hydrogen gas from the first stream, and
sending the hydrogen gas into the second stream.

3. The method of claim 1, wherein the reformer/hydrogen generation system is any one of:
a steam reforming system,
a partial oxidation reforming system,
an autothermal reforming system,
a plasma reformer system,
a plasma electrolysis system
a plasma torch,
a plasma microwave system,
a catalytic system, or
a plasma pyrolysis system.

4. The method of claim 3, further comprising:
storing hydrogen generated by the reformer/hydrogen generation system in a hydrogen buffer tank.

5. A method of enhancing diesel fuel combustion by adding reformed hydrogen to the diesel fuel, by:
(a) extracting hydrogen gas from liquid diesel fuel with a reformer/hydrogen generation system;
(b) bubbling and agitating the extracted hydrogen gas into the liquid diesel fuel to form a homogenous mixture of hydrogen gas in liquid diesel fuel;
(c) compressing the homogenous mixture of hydrogen gas in liquid diesel fuel at high pressures; and then
(c) receiving air into a combustion chamber; while
(d) receiving the compressed homogenous mixture of hydrogen gas in liquid diesel fuel into the combustion chamber.

6. The method of claim 5, wherein the hydrogen gas is extracted from the liquid diesel fuel by sending a portion of the diesel fuel into a reformer/hydrogen generation system.

7. The method of claim 6, wherein the extracted hydrogen gas is bubbled into the liquid diesel fuel in an infuser/mixer.

8. The method of claim 5, wherein the reformer/hydrogen generation system is any one of:
a steam reforming system,
a partial oxidation reforming system,
an autothermal reforming system,
a plasma reformer system,
a plasma electrolysis system
a plasma torch,
a plasma microwave system,
a catalytic system, or
a plasma pyrolysis system.

9. A system for enhancing diesel fuel combustion by adding reformed hydrogen to diesel fuel, comprising:
(a) a liquid diesel fuel tank;
(b) a reformer/hydrogen generation system, wherein the reformer/hydrogen generation system generates hydrogen gas from the liquid diesel fuel received from the liquid diesel fuel tank;
(c) an infuser/mixer, wherein the infuser/mixer receives the liquid diesel fuel from the liquid diesel fuel tank, and receives the hydrogen gas from the reformer/hydrogen generation system, and bubbles the hydrogen gas into the liquid diesel fuel to form a homogenous mixture of hydrogen gas in liquid diesel fuel;
(d) a lift pump for moving the homogenous mixture of hydrogen gas in liquid diesel fuel out of the infuser/mixer;
(e) a diesel engine having a combustion chamber; and
(f) an injector for moving the homogenous mixture of hydrogen gas in liquid diesel fuel from the lift pump to the combustion chamber.

10. The system of claim 9, wherein a first portion of the diesel fuel in the diesel fuel tank passes directly into the reformer/hydrogen generation system and a second portion of the diesel fuel in the diesel fuel tank passes directly into the infuser/mixer.

11. The system of claim 9, further comprising:
a hydrogen buffer tank between the reformer/hydrogen generation system and the infuser/mixer.

12. The system of claim 9, further comprising:
an air inlet into the combustion chamber.

13. The system of claim 9, wherein the reformer/hydrogen generation system is any one of:
a steam reforming system,
a partial oxidation reforming system,
an autothermal reforming system,
a plasma reformer system,
a plasma electrolysis system
a plasma torch,
a plasma microwave system,
a catalytic system, or
a plasma pyrolysis system.
